(19) United States
(12) Patent Application Publication
(10) Pub. No.: US 2012/0207360 A1
(43) Pub. Date: Aug. 16, 2012

(54) Systems and Methods for Object Identification

(76) Inventors: Courosh Mehanian, Redmond, WA (US); Peter J. Lorenzen, Bellevue, WA (US); Matthew T. Lee, Seattle, WA (US); Yanning Zhu, Snoqualmie, WA (US)

(21) Appl. No.: 13/025,755

(22) Filed: Feb. 11, 2011

(51) Int. Cl. G06K 9/62; G06K 9/46; G06K 9/34; G06K 9/00

(52) U.S. Cl. 382/128; 382/224; 382/190; 382/164

(57) ABSTRACT

Systems and methods for object identification. Objects in a color image of a biological sample are identified by using a signal function to transform the color image into a single-channel image with localized extrema. The localized extrema may be segmented into objects by an iterative thresholding process and a merit function may be used to determine the quality of a given result.

### FIELD OF THE INVENTION

The present invention relates to systems and methods for identifying objects in an image, and in particular multi-channel images.

### BACKGROUND OF THE INVENTION

Toxicologic pathology is the study of functional and structural changes induced in cells, tissues and organs by external stimuli such as drugs and toxins. Toxicologic studies are helpful to assessing the safety of drugs, vaccines, and other chemicals. A typical toxicologic study involves the controlled administration of at least one substance to a population of test animals. Tissue is harvested from the population using surgical processes such as necropsy. The harvested tissue is typically stained to improve the visibility of various tissue components. After processing, the tissue is mounted on a transparent substrate for viewing or digital imaging. By viewing the specimens, a diagnostician can identify the effects of the administered substance on the members of the test population.

The diagnostician faces several challenges as he or she studies specimen images. Different laboratories may process samples using different processes that may result in variations in color, contrast, or hue. The same variations may even arise in tissues processed in the same laboratory, for example, between tissues processed by different technicians or under different conditions. The diagnostician must exercise his or her judgment to distinguish between artifacts and clinically-significant features. When the diagnostician is reviewing a set of hundreds or even thousands of samples, human fallibility may cause artifacts to be deemed clinically significant features and vice versa.

Accordingly, there is a need for systems and methods for automatically identifying objects of interest.

### SUMMARY OF THE INVENTION

Embodiments of the present invention provide systems and methods for the identification of objects in images of biological samples.

The system may spatially identify (or segment) tissue regions and objects in images of biological samples, responding to color differences that are histo-pathologically significant, while ignoring inconsequential differences. The system may handle color (multi-channel) or grayscale images in a color-invariant manner, maintaining sensitivity to significant color differences and ignoring inconsequential color differences. The system can detect and segment objects with learned models (using classifiers) or user defined objects by contrast with the background.

One application for embodiments of the present invention is for use as an object segmenter, which may be part of a broader automated system for analyzing images, allowing the analyzing system to perform robustly in the presence of lab-to-lab, specimen-to-specimen, and scanner-to-scanner variation, along with other factors that give rise to inconsequential color changes. This robustness to color variation is a required attribute of both clinical and pre-clinical computer-automated pathology systems.

In one aspect, embodiments of the present invention provide a system for identifying objects in an image. The system includes a database with a multi-channel input image of a sample, a collapsing element utilizing a signal function to transform the multi-channel input image into a single-channel image defining an image domain with a plurality of localized extrema, a thresholding element to iteratively apply a varying threshold value to the single-channel image to segment objects in the image, and an assignment element utilizing a merit function that assigns merit function values to segmented objects to determine qualified objects in the image. The system also includes a classification element for classifying at least some of the qualified objects as detected objects, an organizing element for creating at least one data structure utilizing the detected objects such that each data structure consists of detected objects at approximately the same location in the image domain, and an identification element for selecting at least some of the detected objects utilizing the created data structures.

In various embodiments, the sample is a biological sample. In other embodiments, the form of the signal function is a rational function, a general non-linear function, a general linear transform, or a linear transform with coefficients computed via a principal component analysis formalism. In another embodiment, the threshold values applied by the thresholding element are predetermined. The thresholding element may be a threshold series with evenly spaced values between a lower and an upper limit and/or values computed based on a cumulative distribution function of the single-channel image. In still another embodiment, the merit function of the assignment element may be based on at least one feature or combination of features of the segmented objects. In other embodiments, the classification element is a pass-through. In yet other embodiments, the classification element may be a single-class or multi-class classifier. The classification element may compute a confidence value that a qualified object belongs to a target class and/or estimate a posterior probability that a qualified object belongs to a target class.

In another aspect, embodiments of the present invention identify objects in an image by providing a multi-channel image of a sample, applying a signal function to the multi-channel image to create a single-channel image defining an image domain and including a plurality of localized extrema, iteratively applying a varying threshold value to the single-channel image to segment objects in the image, and iteratively computing merit function values of segmented objects to determine qualified objects in the image. The method for identifying objects also includes classifying at least some of the qualified objects as detected objects, creating at least one data structure utilizing the detected objects such that each data structure consists of detected objects at approximately the same location in the image domain, and selecting at least some of the detected objects utilizing the created data structures.

In various embodiments, the sample is a biological sample. In other embodiments, the signal function prioritizes contrasting the localized extrema with background values and/or minimizing an impact of color variation, and may assign low or high values to the localized extrema. In another embodiment, a series of threshold values are applied in an ascending or a descending order. In still other embodiments, the method includes computing a series of merit function values for each individual object in view at each threshold value. The method may include computing a single merit function value for all the objects in at least one section of the single-channel image at each threshold value. The method may also include determining that a segmented object is a qualified object if it achieves one of a local and global maximum of a series of merit function values and extracting features from the qualified objects. The method may include computing a confidence value that a qualified object belongs to a target class and/or a posterior probability that a qualified object belongs to a target class. In another embodiment, the method includes accepting the first detected object at each location in the image domain and rejecting any further segmented objects at approximately the same location in the image domain. In still other embodiments, the method may include storing detected objects and associated merit function values, confidence values, posterior probabilities, and extracted features in memory. A selection algorithm may select at least one of the stored detected objects based on the associated merit function values, confidence values, posterior probabilities, and extracted features of the detected objects which form the data structure. In a further embodiment, the method includes modifying the at least one data structure based on a modification algorithm. In another embodiment, the modification algorithm modifies the at least one data structure based on associated merit function values, confidence values, posterior probabilities, or extracted features of objects in the data structure.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1A is an example of an input image for processing by an embodiment of the present invention;

FIG. 1B is an example of an output image of a signal function applied to the input image of FIG. 1A, in accordance with an embodiment of the present invention;

FIG. 2 is a depiction of the output image of FIG. 1B interpreted as a two-dimensional surface;

FIG. 3A is a depiction of an early stage of applying threshold values in a descending order on the surface of FIG. 2;

FIG. 3B is a depiction of a later stage of applying threshold values in a descending order on the surface of FIG. 2; and

FIG. 4 is a depiction of the merging or splitting of segmented objects resulting from iteratively applying a varying threshold value for an embodiment in which the extrema are peaks.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

Embodiments of the present invention provide a system for identifying objects in images. The input images may be multi-channel or grayscale images from any of a number of sources. One common source is images of stained microscope slides. The slides may be stained according to a number of protocols, such as the hematoxylin and eosin (H & E) and the immunohistochemistry (IHC) protocols. The images may be defined in any of a number of color spaces, including, but not limited to, RGB, L*a*b, and HSV. The following discussion assumes an RGB image of a stained microscope slide, but it is to be understood that this example does not limit the domain of applicability of the current invention in any manner.

A toxicologic pathology study involves the administration of a drug to a plurality of animals, usually in various dose groups, including a control group. After the animals are sacrificed, typically one or more tissues are sectioned, stained, and mounted on microscope slides. The slides or digital images of the tissues may then be reviewed by pathologists or by an automated pathology system, or a combination thereof.

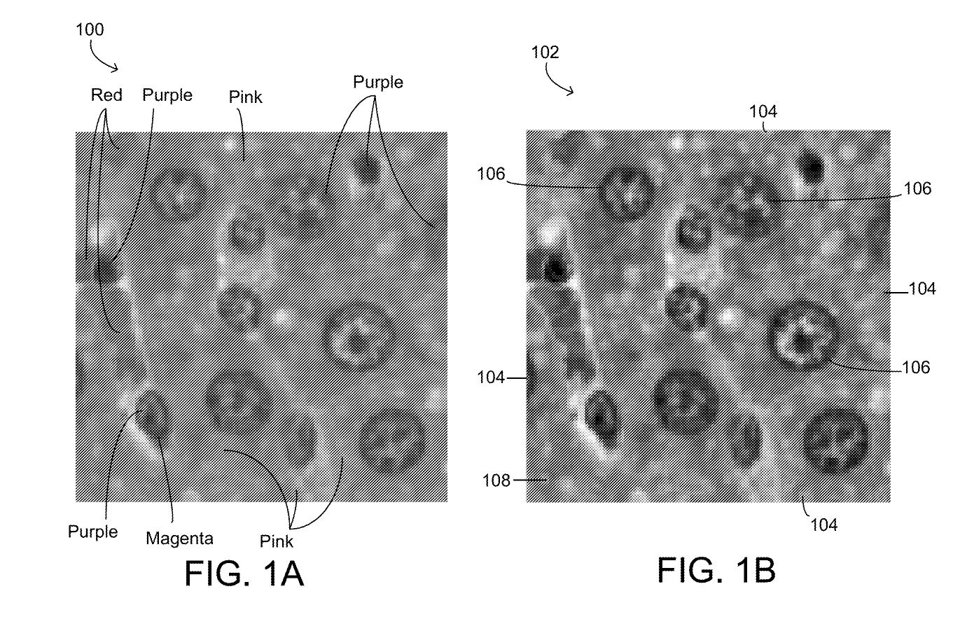

With reference to FIG. 1A, a multi-channel input image 100 stored in a database represents a magnified biological sample in the RGB color space. The RGB color space combines information from red, green, and blue channels to create a variety of colors and shades to depict various features in the image 100, such as the colors generally described in FIG. 1A. A collapsing element applies a signal function to the multi-channel image 100 to transform it into a single-channel signal image 102, as seen in FIG. 1B. The boundaries 104 of the single-channel image 102 define an image domain.

The signal function induces an ordering of pixels with respect to the progressive series of thresholds that comprise a thresholding element. For a particular image, objects of interest appear as areas of localized extrema 106 which are distinct from the background 108. The localized extrema 106 may consist of values that are higher or lower than the background 108, depending on the signal function used. The signal function may be selected based upon a number of performance characteristics. One important criterion is to induce an ordering of objects that remains consistent under the effect of color variation. For example, a signal function chosen for red blood cell segmentation should cause red objects to appear as the extrema in different single-channel images (e.g., an image A and an image B), even if there is color variation between the two source images (e.g., as a result of staining differences). Other performance criteria may be relevant as well, such as maximizing contrast between the background 108 and an object to be segmented and minimizing the amount of signal variation resulting from color variation (i.e., diminishing the impact of color variation).

The signal function may be a rational function, a general non-linear function, a general linear transform, or a linear transform with coefficients computed via a principal component analysis formalism, as is well known in the art. There are no formal limitations on the form of this function. In one embodiment, the signal function averages the red, green, and blue channels. The form of a signal function used to minimize signal variation may be dependent upon the manner in which the color variation affects each image channel. For example, if the color variation results from a blanket amplification of color levels, using a ratio-of-channels signal function would cancel the color variation. In some instances, selecting a signal function to achieve either a higher contrast or a lower signal variation may result in lower performance with regard to the unselected attribute, such as using a function that maps all colors to the same signal level; color variation is completely eliminated, but so is contrast. However, it may be generally possible to select a signal function that optimizes the tradeoff between the higher contrast and lower signal variation criteria. For example, the signal function S=R/(B+G+1), where R stands for the red channel, B for the blue channel, and G for the green channel in an RGB image, causes red features in the image to stand out as peaks, while cancelling out signal variation resulting from blanket amplification of color levels.

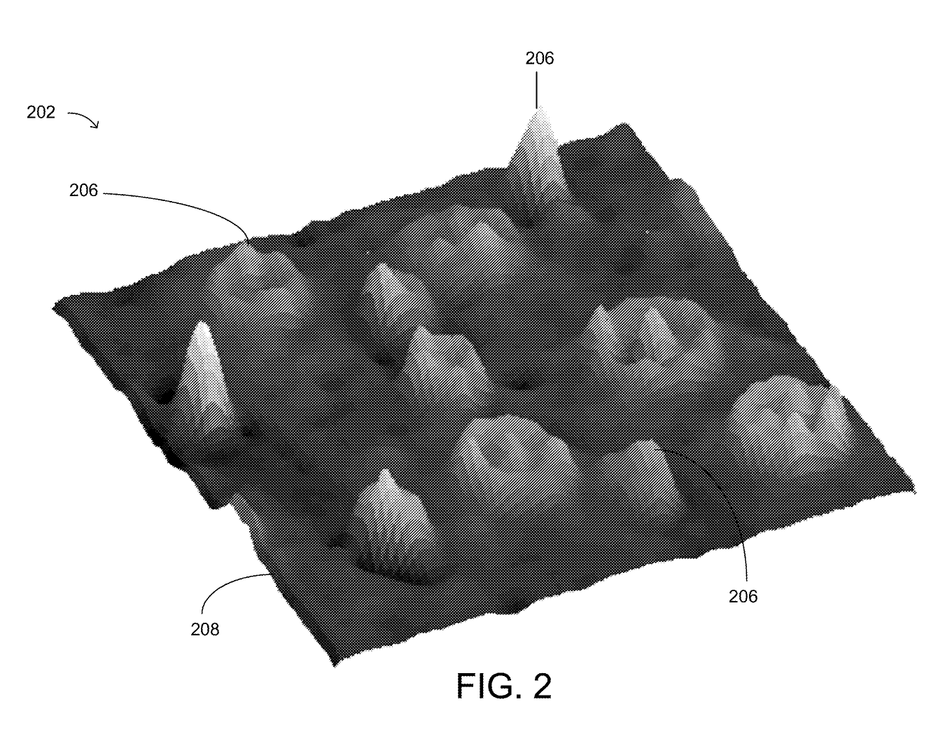

With reference to FIG. 2, after application of the signal function, the signal image 102 may be visualized as a two-dimensional signal image surface 202 over the same image domain defined by the boundaries 104. In this embodiment, extrema 206 (nuclei from FIG. 1B, as processed by the selected signal function) are depicted as peaks relative to a background surface 208, though they may also be depicted as valleys in other embodiments, depending on the signal function.

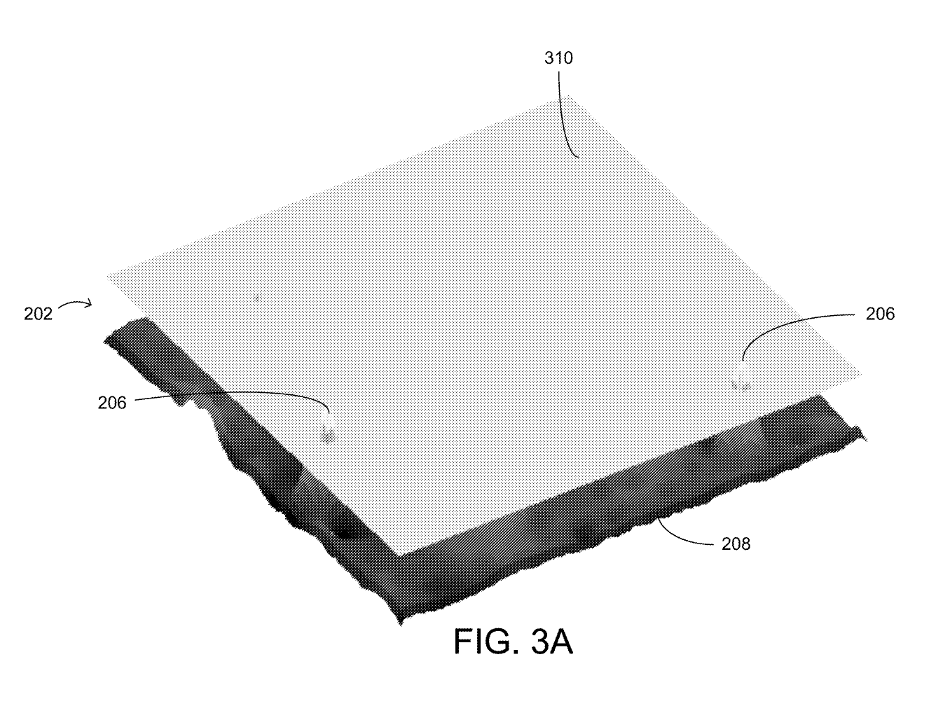

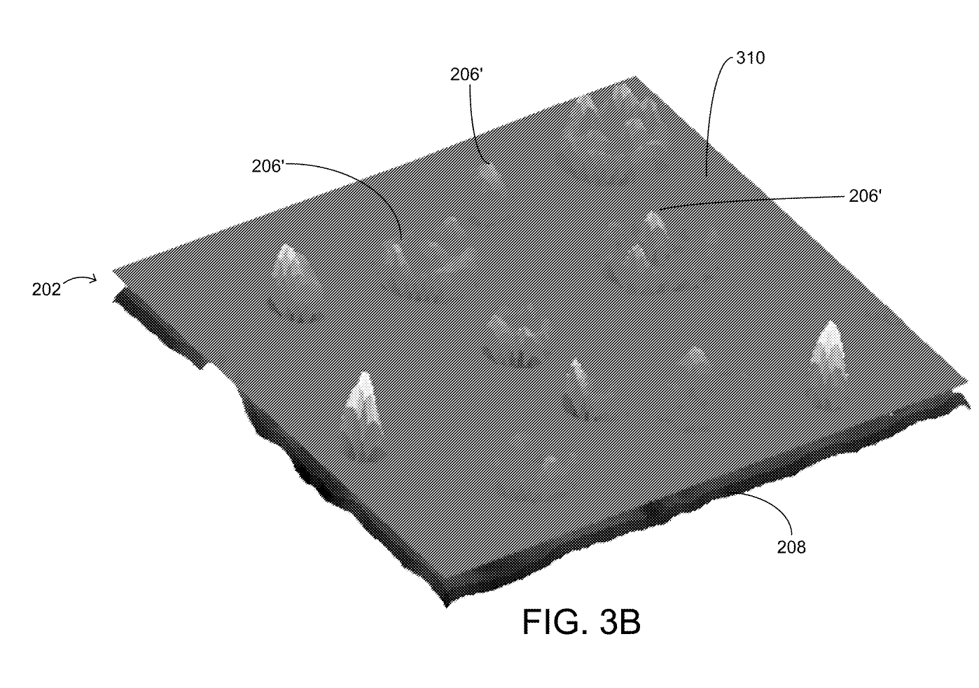

Next, a varying threshold may be applied to the single-channel image to identify objects for segmentation. This process can be understood visually, with reference to FIGS. 3A and 3B, as the application of a threshold plane 310 (representing a threshold value) to the signal image surface 202 by a thresholding element to determine which areas contain objects that should be considered segmented objects (i.e., those that extend above the threshold plane 310). The thresholding element is responsive to a user input dictating its operation, including inputs relating to the computation of a series of predetermined threshold values (defining a threshold series), an optimal threshold applied, and subsequent processing steps, each as described below. In one embodiment, the series of thresholds are evenly spaced values between an upper and lower limit. In another embodiment, the series of thresholds are computed based on the cumulative distribution function of the signal with respect to the image 102, such that a fixed number of pixels are contained in each threshold interval.

The signal function may cause the extrema 206 to appear as peaks, and the threshold value may start at a high value and be iteratively applied in a descending order. For the same signal function, the threshold value may also start low and be applied in an ascending order. In other embodiments, the signal function may cause the extrema 206 to appear as valleys, and the threshold series may be applied in descending or ascending order. Going back to the illustrated embodiment, at the relatively high threshold value used early in the process, as depicted in FIG. 3A, only a few extrema 206 extend beyond the threshold plane 310. Further along in the process, with a lower threshold value, several additional extrema 206′ may extend beyond the threshold plane 310, as depicted in FIG. 3B.

As can be appreciated, an appropriate or optimal threshold value should be reached before determining that the desired objects have been properly segmented. This may be accomplished through the use of an assignment element utilizing a merit function that determines the quality of a particular segmentation result. Using an algorithm to calculate a threshold that maximizes the merit function value in turn helps ensure that the best result is achieved. The merit function may be based on any feature or combination of features computed from the segmentation result and may be designed to favor outcomes with particular characteristics. For example, a merit function proportional to a measure of “roundness” will produce objects that tend to be round. Another embodiment of a merit function may measure an overlap of qualified object boundaries with a pre-determined map, such as a Canny edge map, to produce objects whose edges tend to coincide with the Canny edges.

The scope of the merit function may vary, and may be computed on a user-selectable range of objects. In one embodiment, a single merit function value is computed for all of the objects in the field of view in each threshold iteration to create a series of merit function values. In turn, the optimal threshold may be determined for, and applied to, the entire image domain. All objects segmented by the optimal threshold may be considered qualified objects. Alternatively, a single merit function value may be computed for a particular section (such as a user defined section) of the image domain at each threshold iteration. In another embodiment, individual objects (or blobs) are isolated via connected component analysis. The merit function value may be computed for each blob individually in each threshold iteration to create a series of merit function values. The algorithm may keep track of blobs based on their location, as well as keeping track of the associated merit function values. Blobs that achieve a local or global maximum merit function value of the series of merit function values may be considered qualified objects.

All of the qualified objects may be processed through a classification element for classifying at least some of the qualified objects as detected objects of a target class based on extracted features. The extracted features taken from the qualified objects, for example, may consist of the set “roundness,” “area,” “eccentricity,” “mean intensity,” and “signal entropy.” Other embodiments may extract different feature sets. In one embodiment, the classification element is a pass-through, classifying all of the qualified objects as detected objects. In other embodiments, the classification element is a single-class or multi-class classifier, trained using ground-truth data sets of objects that are known to belong to the target class. Single-class classifiers may determine whether an object belongs to a target class or, more generally, compute a confidence value that an object belongs to a target class. Multi-class classifiers may determine which class among a set of target classes an object belongs to or, more generally, compute a confidence value that an object belongs to each of a set of target classes. When properly calibrated, the confidence value may be an estimate of the posterior probability that an object belongs to a target class. In embodiment where the merit function is limited to one blob at a time, as previously described, the confidence values or posterior probabilities of the blobs may be tracked along with their locations and related merit function values. Each blob may be individually evaluated as to whether it belongs to a target class, and thus whether it is classified as a detected object.

The detected objects may be processed based, in part, on user input. An organizing element may create at least one data structure utilizing the detected objects. Each data structure may consist of detected objects at approximately the same location in the image domain. An identification element may then be used to select at least some of the detected objects utilizing the created data structures. In one embodiment, all detected objects in the current threshold iteration are accepted as final. Subsequent qualified objects from later threshold iterations in approximately the same location as a previously accepted object may be removed from further consideration.

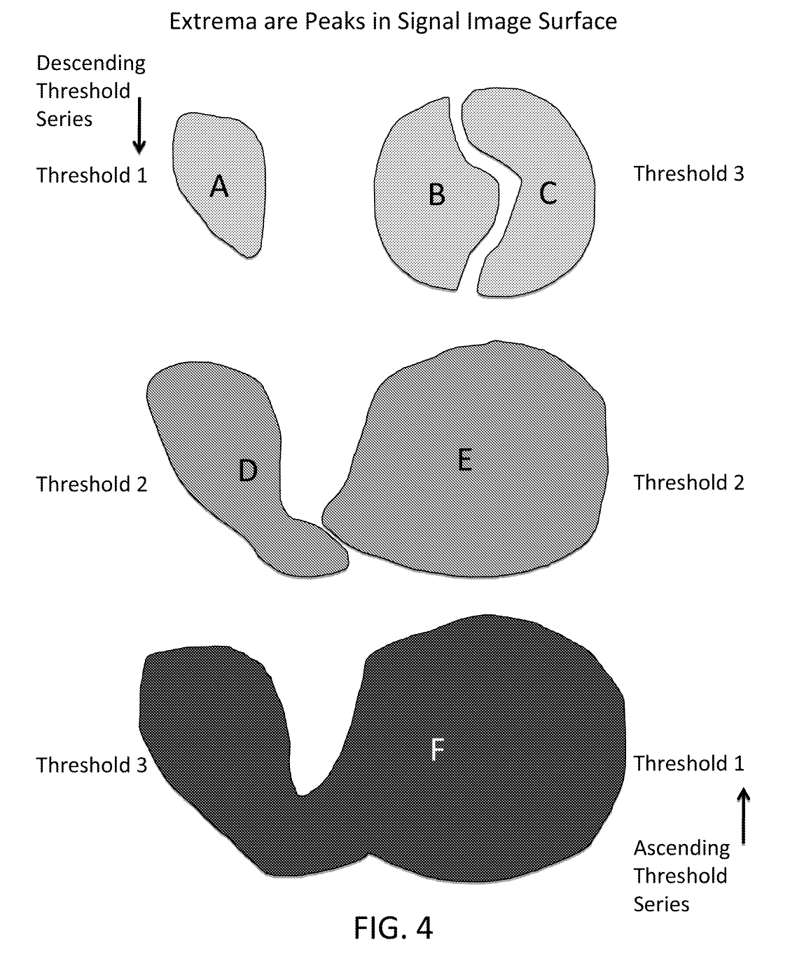

In another embodiment, the detected objects are stored in memory, along with their associated merit function values, confidence values, posterior probabilities, and extracted features. Subsequent qualified objects from later threshold iterations in approximately the same location as a previously accepted object may be tracked as belonging to a common construct, called a “tree.” As a selection algorithm iterates through the threshold series, qualified objects may merge or split, depending on whether the series of thresholds is traversed in descending or ascending order, respectively, in embodiments where the signal function creates extrema that are peaks. Each tree may correspond to a root object that emerges from merging multiple objects at different levels of the iteration, or a root object that split into multiple objects at different levels of the iteration. This is illustrated in FIG. 4, which corresponds to a signal function creating extrema that are peaks. As indicated in the caption on the left, the threshold series is applied in descending order when moving from top to bottom. In this example, at the first threshold level, Threshold 1, three objects A, B, and C are segmented. At Threshold 2, objects B and C merge into one object E, and object A grows to become object D. At Threshold 3, objects D and E merge into one object F. As indicated in the caption on the right, the threshold series is traversed in ascending order when moving from bottom to top. At Threshold 1, one object F is segmented as a single object. At Threshold 2, object F splits into two objects D and E. At Threshold 3, object E splits into two objects B and C, and object D shrinks to object A. The organizing element may keep track of where the tree-like data structures merge and split. The selection algorithm may be used to decide which objects in each tree to select (i.e., where to prune the data structure by removing unnecessary information). In the example shown in FIG. 4, the selection algorithm would have to decide whether to accept the single root object F, or the two objects D and E, or objects D, B, and C, or objects A, B, and C. The selection algorithm may be based on the confidence values, posterior probabilities, merit function values (that may be previously calculated), or extracted features of the detected objects. Once the selection algorithm selects at least one detected object, a modification algorithm may be used to remove the unnecessary information. The modification algorithm may be used to prune the tree above or below the lowest or highest threshold value at which a detected object is selected, and, as it is related to the selection algorithm, may be based on the same criteria as the selection algorithm (e.g., the confidence values, posterior probabilities, merit function values, and extracted features of detected objects). In another embodiment, the first detected object at each location in the image domain may be accepted and any further segmented objects at approximately the same location are rejected as the series of thresholds is traversed successively.

It will therefore be seen that the foregoing represents an advantageous approach to the identification of objects in images of biological samples. The terms and expressions employed herein are used as terms of description and not of limitation and there is no intention, in the use of such terms and expressions, of excluding any equivalents of the features shown and described or portions thereof, and it is recognized that various modifications are possible within the scope of the invention claimed.

What is claimed is:

1. A system for identifying objects in an image, the system comprising:
a database comprising a multi-channel input image of a sample;
a collapsing element utilizing a signal function to transform the multi-channel input image into a single-channel image defining an image domain having a plurality of localized extrema,
a thresholding element to iteratively apply a varying threshold value to the single-channel image to segment objects in the image;
an assignment element utilizing a merit function that assigns merit function values to segmented objects to determine qualified objects in the image;
a classification element for classifying at least some of the qualified objects as detected objects;
an organizing element for creating at least one data structure utilizing the detected objects such that each data structure consists of detected objects at approximately the same location in the image domain; and
an identification element for selecting at least some of the detected objects utilizing the created data structures.

2. The system of claim 1, wherein the sample comprises a biological sample.

3. The system of claim 1, wherein the form of the signal function is selected from the group consisting of a rational function, a general non-linear function, a general linear transform, and a linear transform with coefficients computed via a principal component analysis formalism.

4. The system of claim 1, wherein the threshold values applied by the thresholding element are predetermined.

5. The system of claim 4, wherein the thresholding element utilizes a threshold series comprising the predetermined values.

6. The system of claim 5, wherein the threshold series comprises at least one of evenly spaced values between a lower and an upper limit and values computed based on a cumulative distribution function of the single-channel image.

7. The system of claim 1, wherein the merit function is based on at least one feature or combination of features of the segmented objects.

8. The system of claim 1, wherein the classification element is a pass-through.

9. The system of claim 1, wherein the classification element is selected from the group consisting of a single-class classifier and a multi-class classifier.

10. The system of claim 9, wherein the classification element performs at least one of computing a confidence value that a qualified object belongs to a target class and estimating a posterior probability that a qualified object belongs to a target class.

11. A method of identifying objects in an image, the method comprising:
providing a multi-channel image of a sample;
applying a signal function to the multi-channel image to create a single-channel image defining an image domain having a plurality of localized extrema;
iteratively applying a varying threshold value to the single-channel image to segment objects in the image;
iteratively computing merit function values of segmented objects to determine qualified objects in the image;
classifying at least some of the qualified objects as detected objects;
creating at least one data structure utilizing the detected objects such that each data structure consists of detected objects at approximately the same location in the image domain; and
selecting at least some of the detected objects utilizing the created data structures.

12. The method of claim 11, wherein the sample comprises a biological sample.

13. The method of claim 11, wherein the signal function prioritizes at least one of contrasting the localized extrema with background values and minimizing an impact of color variation.

14. The method of claim 11, wherein the signal function assigns one of low and high values to the localized extrema.

15. The method of claim 11, wherein a series of threshold values are applied in one of an ascending and a descending order.

16. The method of claim 11 further comprising the step of computing a series of merit function values for each individual object in view at each threshold value.

17. The method of claim 11 further comprising the step of computing a single merit function value for all the objects in at least one section of the single-channel image at each threshold value.

18. The method of claim 11 further comprising the step of determining that a segmented object is a qualified object if it achieves one of a local and global maximum of a series of merit function values.

19. The method of claim 11 further comprising the step of extracting features from the qualified objects.

20. The method of claim 11 further comprising the step of computing at least one of a confidence value that a qualified object belongs to a target class and a posterior probability that a qualified object belongs to a target class.

21. The method of claim 11, further comprising the steps of accepting the first detected object at each location in the image domain and rejecting any further segmented objects at approximately the same location in the image domain.

22. The method of claim 11 further comprising the step of storing detected objects and associated merit function values, confidence values, posterior probabilities, and extracted features in memory.

23. The method of claim 22, wherein a selection algorithm selects at least one of the stored detected objects based on the associated merit function values, confidence values, posterior probabilities, and extracted features of the detected objects which comprise the data structure.

24. The method of claim 23 further comprising the step of modifying the at least one data structure based on a modification algorithm.

25. The method of claim 24, wherein the modification algorithm modifies the at least one data structure based on associated values selected from the group consisting of merit function values, confidence values, posterior probabilities, and extracted features.
